(19) United States
(12) Patent Application Publication
(10) Pub. No.: US 2015/0160873 A1
(43) Pub. Date: Jun. 11, 2015

(54) FILESYSTEM TUNED FIRMWARE FOR STORAGE MODULES

(71) Applicant: Memory Technologies LLC, Las Vegas, NV (US)

(72) Inventor: Kimmo Juhani Mylly, Ylojarvi (FI)

(21) Appl. No.: 14/566,647

(22) Filed: Dec. 10, 2014

Related U.S. Application Data
(60) Provisional application No. 61/914,316, filed on Dec. 10, 2013.

(51) Int. Cl. G06F 3/06

(52) U.S. Cl. CPC G06F 3/0619; G06F 3/065; G06F 3/0643; G06F 3/0673

(57) ABSTRACT

Embodiments include a storage device comprising a plurality of memory blocks each having a plurality of memory cells for storing data. The plurality of memory cells collectively forming a mass storage. Firmware includes first operating instructions to manage a first portion of the mass storage, and the first operating instructions are associated with a first type of file system. A controller is configured to manage at least the first portion based at least in part upon the first operating instructions in the firmware. The controller is operable to provide an indication related to a mismatch between the first type of file system and a second type of file system detected to be used by a host device.

### RELATED APPLICATIONS

The present application claims priority to U.S. Provisional Application No. 61/914,316, filed Dec. 10, 2013, and entitled “FILESYSTEM TUNED FIRMWARE FOR STORAGE MODULES,” the entirety of which is incorporated herein. This application is related to U.S. application Ser. No. 12/455,763, filed Jun. 4, 2009, now patented as U.S. Pat. No. 8,874,824, and U.S. application Ser. No. 11/176,669, filed Jul. 8, 2005, now patented as U.S. Pat. No. 7,827,370, each of which are assigned to the assignee of the present application. Each of these related applications are incorporated herein by reference in their entireties.

### BACKGROUND

Managed storage modules, such as managed NAND storage modules, provide many benefits over using raw memories such as flash NAND memories. Managed storage modules, which typically include a storage controller combined with NAND memory in the case of managed NAND or other types of memory in other cases, provide several benefits to device manufacturers. The storage controller hides the details of the memory (e.g., NAND) and provides the intended interface and other features, such as ECC support without the device manufacturers having to implement those features on the host side (e.g., on a smartphone or tablet). Additionally, managed storage modules allow new advanced features to be implemented in the storage controller without the host necessarily having to be aware that the features exist. The advanced features may either be activated or not used depending by the storage controller or depending on whether the host supports the features. Thus, managed storage modules help with backwards compatibility.

Examples of managed storage modules (e.g., managed storage devices), and in particular managed NAND storage modules, include embedded multimedia cards (eMMC), Universal Flash Storage (UFS), solid-state drive (SSD) modules. These modules are used in wide variety of applications like mobile phones, Global positioning system (GPS) devices, media players, PCs, and servers for storing the operating system code, applications, and user data, such as, the operating system (OS) code, photos, and videos. Often, the storage controller is implemented with a combination of special hardware that performs specific functions and firmware (FW) that allows controller executable instructions from firmware or other operating code to perform the functions of the storage controller.

Even though there is intelligence in the storage controller and/or in FW operating the storage controller, especially related to the management of the flash (the so called flash translation layer), typical storage module implementations do not know anything about the structure of the file system or data stored on them.

### SUMMARY

Embodiments include a storage module comprising a plurality of memory blocks each having a plurality of memory cells for storing data, the memory cells collectively together forming a mass storage having a filesystem stored thereon in a first portion, wherein the filesystem is of a first type. The storage module includes a firmware that stores first operating instructions to manage the first portion, the first operating instructions being associated with the first type of filesystem. The storage module includes a controller configured to manage the first portion based on the first operating instructions in the firmware.

Embodiments of the present disclosure include a storage device comprising a plurality of memory blocks each having a plurality of memory cells for storing data, the plurality of memory cells collectively forming a mass storage. The storage device includes firmware that includes first operating instructions to manage a first portion of the mass storage, the first operating instructions being associated with a first type of file system. The storage device includes a controller configured to manage at least the first portion based at least in part upon the first operating instructions in the firmware, the controller operable to provide an indication related to a mismatch between the first type of file system and a second type of file system detected to be used by a host device.

In some embodiments, the indication relates to a request for the host device to cause installation of second operating instructions to manage a second portion of the mass storage based at least in part upon the second operating instructions. The second operating instructions are associated with the second type of file system.

In some embodiments, the controller is further configured to detect the second type of file system by analyzing at least a portion of the data stored in the mass storage. In some embodiments, the controller is further configured to detect the second type of file system by reading a register of the storage device that has previously been written with another indication of the second type of file system. In some embodiments, the controller is further configured to detect the first type of file system. In some embodiments, the controller is further configured to store another indication of the first type of file system and to transmit the other indication to the host device. In some embodiments, the controller is further configured to read the other indication of the first type of file system.

In some embodiments, the storage device includes a register for storing a parameter related to operation of the first type of file system, wherein the firmware includes instructions to read the parameter and to configure the first operating instructions to manage the mass storage based on the parameter.

Embodiments of the present disclosure include a storage device comprising a mass storage and a controller configured to manage at least a first portion of the mass storage based at least in part upon first operating instructions in a firmware of the storage device. The controller is operable to provide an indication related to a mismatch between the first type of file system and a second type of file system detected to be used by a host device.

In some embodiments, the indication relates to a request for the host device to cause installation of second operating instructions to manage a second portion of the mass storage based at least in part upon the second operating instructions. The second operating instructions are associated with the second type of file system.

In some embodiments, the controller is further configured to detect the second type of file system by analyzing at least a portion of data stored in the mass storage. In some embodiments, the controller is further configured to detect the second type of file system by reading a register of the storage device that has previously been written with another indication of the second type of file system. In some embodiments, the controller is further configured to detect the first type of file system. In some embodiments, the controller is further configured to store another indication of the first type of file system and transmit the other indication to the host device. In some embodiments, the controller is further configured to read the other indication of the first type of file system.

In some embodiments, the storage device includes a register for storing a parameter related to operation of the first type of file system, wherein the firmware includes instructions to read the parameter and configure the first operating instructions to manage the mass storage based on the parameter.

Embodiments of the present disclosure include a method that comprises storing, by a controller of a storage device, data in a mass storage of the storage device. The method includes managing, by the controller of the storage device, at least a first portion of the mass storage based at least in part upon first operating instructions in a firmware of the storage device and providing an indication related to a mismatch between the first type of file system and a second type of file system detected to be used by a host device.

In some embodiments, the indication relates to a request for the host device to cause installation of second operating instructions to manage a second portion of the mass storage based at least in part upon the second operating instructions, the second operating instructions being associated with the second type of file system. In some embodiments, the method further comprises detecting the second type of file system by one or more of analyzing at least a portion of the data stored in the mass storage, or reading a register of the storage device that has previously been written with another indication of the second type of file system. In some embodiments, the method further comprises detecting the first type of file system, storing another indication of the first type of file system, and transmitting the other indication to the host device.

Embodiments of the present disclosure include a host device comprising an interface for interfacing the host device with a storage device that comprises a plurality of memory circuits for storing data. The storage device includes a firmware having first operating instructions to manage a first portion of the mass storage, the first operating instructions being associated with a first type of file system. The host device further comprises a host controller configured to receive, from the storage device, an indication related to a mismatch between the first type of file system and a second type of file system being used by the host device, and to provide to the storage device second operating instructions, the second operating instructions being associated with the second type of file system. In some embodiments, the indication relates to a request for the host device to cause installation of the second operating instructions. In some embodiments, the second operating instructions are for managing a second portion of the mass storage based at least in part upon the second operating instructions.

Embodiments of the present disclosure include a storage device, comprising, means for storing data, means for managing the means for storing data, including managing at least a first portion of the means for storing data based at least in part upon first operating instructions in a firmware, the first operating instructions being associated with a first type of file system. The storage device further comprises means for providing an indication related to a mismatch between the first type of file system and a second type of file system detected to be used by a host device. In some embodiments, the indication relates to a request for the host device to cause installation of second operating instructions to manage a second portion of the mass storage based at least in part upon the second operating instructions, the second operating instructions being associated with the second type of file system.

### BRIEF DESCRIPTION OF THE DRAWINGS

FIG. 1 depicts an example host device.

FIG. 2 depicts an embodiment of a storage module.

The figures depict embodiments of the present disclosure for purposes of illustration only. One skilled in the art will readily recognize from the following discussion that alternative embodiments of the structures and methods illustrated herein may be employed without departing from embodiments described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Because a storage controller of a managed storage module (e.g., a managed storage device) provides an abstraction layer for the management of the mass storage area of the module, the storage controller may not know anything about the file system or types of data that are being stored in the mass storage area. This means that the managed storage module may manage the mass storage area in a manner that is agnostic to the particular features or behavior of the file system stored in the mass storage area. For example, a journaling file system (e.g., ext3, JFS, or ext4) may be treated exactly the same as a non-journaling file system (e.g., ext2, FAT32, or VFAT). In other examples, different file systems may implement a file allocation table (FAT) using different methodologies.

Having a managed storage module that is agnostic to the file system being stored thereon may result in un-optimized or lower performance and/or lower reliability across a wide range of file systems. In other words, while the managed storage module may work with any file system, performance and/or reliability may not be optimized, or may be worse than it might be, because the managed storage module is not accounting for the specific features and operation of the file system that is actually being stored. Therefore, embodiments of the present disclosure address this issue by allowing for the managed storage module to know what file system is stored thereon and to adjust the management of the mass storage area in response to the features or operation of the file system.

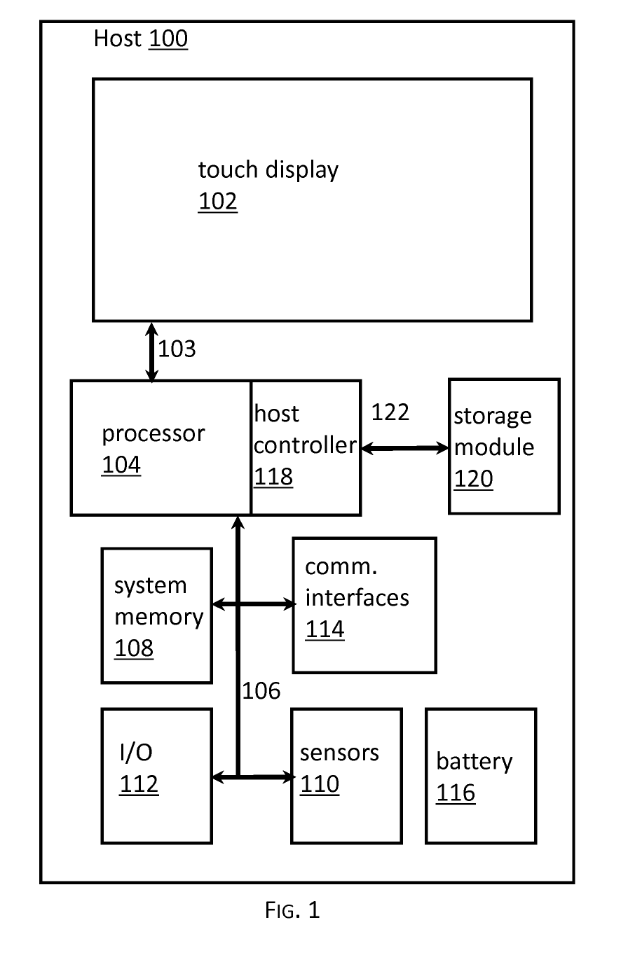

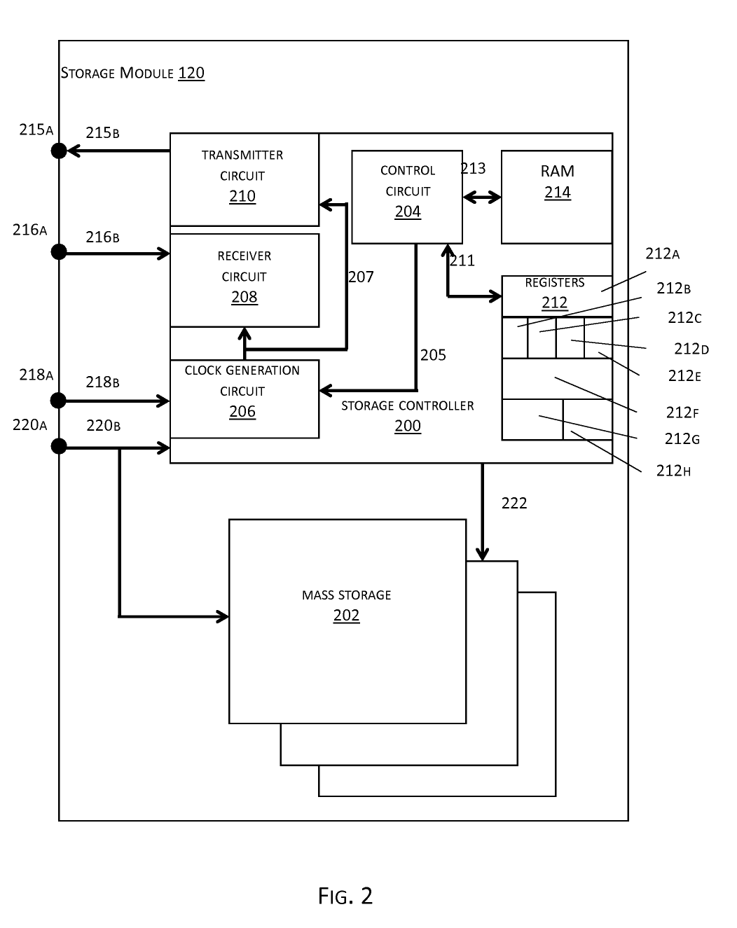

FIG. 1 depicts an example host 100, e.g., a host device such as a smartphone device or a tablet device, which may utilize embodiments of the present disclosure. Host 100 includes a touch display 102 that is sensitive to a user's touch based on capacitive or resistive detection. Bus 103 connects touch display 102 to processor 104, which may include a graphics subsystem that handles the display of graphics and text on touch display 102. Host 100 also includes a number of other components connected to processor 104 through shared bus 106, including system memory 108 (e.g., DRAM), sensors 110 (e.g., accelerometers, gyroscope, GPS), input/output (I/O) 112 (e.g., a speaker, a microphone, or a keyboard), and communications interfaces 114 (e.g., Universal Serial Bus (USB), WiFi, Bluetooth, or other wired or wireless interfaces). Processor 104 may also include host controller 118 (which may be alternatively connected to but is separate from processor 104) that interfaces with storage module 120 over bus 122. Storage modules according to embodiments, including storage module 120, include one or more storage devices. Alternatively, host controller 118 may interface with storage module 120 over shared bus 106. Both shared bus 106 and bus 122 may include several bus lines for data, commands, clocking signals, power, reset, etc. An example of the bus lines included in bus 122 is described below with respect to FIG. 2. Battery 116 provides power to above described components through a power supply bus and/or lines (not shown).

While the use of storage module 120 is shown in the context of a touch sensitive smartphone or tablet, the present disclosure is not limited to use in such devices. Embodiments of the present disclosure may be applied to any electronic device that utilizes storage, e.g., wearable computers such as smartwatches or glasses, televisions, cameras, netbooks, gaming consoles, personal computers, servers, set top boxes, and the like. Additionally, the architecture of host 100 is provided for illustrative purposes only and should not be considered limiting.

FIG. 2 depicts an exemplary architecture for storage module 120 that may implement embodiments of the present disclosure. Storage module 120 may be a memory storage device contained within a package (e.g. a ball grid array (BGA) package) that is designed to be mounted on a printed circuit board. For example, storage module 120 may be or include an embedded multimedia card (eMMC) or universal flash storage (UFS) module. Alternatively, storage module 120 may be a memory storage device contained within a removable card that fits within a slot on the host 100 or a semi-removable device such as an SSD module or PC/server cards/modules (e.g., Peripheral Component Interconnect Express (PCIe) cards). Additionally, although storage module 120 is shown as being one self-contained storage device, storage module 120 may also be implemented with a collection of interconnected devices.

As shown in FIG. 2, storage module 120 includes storage controller 200 for communicating data between mass storage 202 and host 100 (see FIG. 1). Storage controller 200 includes control circuit 204 for controlling the operation of storage controller 200. Control circuit 204 may be connected to RAM 214 over bus 213 for storing operating information and/or for temporary storage. Storage controller 200 also includes clock generation circuit 206 for generating an internal clocking signal on internal clock line 207, receiver circuit 208 for receiving data and commands from host controller 118 (see FIG. 1), transmitter circuit 210 for transmitting data and status information to host controller 118 (see FIG. 1), and registers 212 for storing information and settings relating to the operation of storage module 120, including information related to the generation of the internal clocking Control circuit 204 may use bus 211 to access or write information to registers 212. Storage module 120 communicates with host controller 118 through data out line 215b and data terminal 215a, which may provide data and status information, and data in line 216b and data terminal 216a, which may provide data, commands, and status information.

Storage module 120 also includes reference clock line 218b and reference clock terminal 218a that provide a reference clock signal to clock generating circuit 206, and power line 220b and power terminal 220a that provide power to storage controller 200 and mass storage 202. While the above lines and terminals are shown to be single lines and terminals in FIG. 2, each line and terminal may be made up of multiple lines and terminals. For example, power terminal 220a may include multiple terminals associated with multiple lines of power line 220b that each individually provide power to the different components (e.g., mass storage 202 and storage controller 200). As another example, data out line 215b and data out terminal 215a or data in line 216b and data in terminal 216a may be implemented using two lines (e.g., a differential pair or a 2-bit wide bus) connected to two terminals. Bus 222 provides for storage controller 200 to read data from and write data to mass storage 202.

Storage module 120 also includes mass storage 202, which includes one or more memory blocks on one or more chips having memory circuits or cells for storing one or more bits of information. For example, mass storage 202 may be implemented with a non-volatile memory such as NAND flash memory having memory cells/circuits (e.g., NAND cells) each capable of storing one bit (single level cell) or multiple bits (multi-level cell) of data. Other forms of non-volatile memory may also be used without departing from the present disclosure. Mass storage 202 may be physically and/or logically divided. For example, mass storage 202 may be implemented as a single chip. Alternatively, mass storage 202 may be implemented with several discrete chips that are connected together in a single package (as shown in FIG. 2) or, alternatively, separately packaged and externally connected together. Mass storage 202 may also be divided up into blocks, which are then further divided into pages. Storage controller 200 is connected to mass storage 202 through bus 222, which allows for storage controller 200 to read data from and write data to mass storage 202.

RAM 214 is present in some embodiments of the present disclosure; storage controller 200 may use RAM 214 to store operating information (e.g., operating code and/or state information). For example, RAM 214 may store a translation table that describes how logical addresses are mapped to physical addresses of mass storage 202. When RAM 214 is not implemented within storage module 120, in some cases, storage controller 200 may instead request and use a portion of system memory 108 of host 100 (see FIG. 1), as described in U.S. patent application Ser. No. 12/455,763, filed Jun. 4, 2009, which is incorporated by reference in its entirety.

Clock generation circuit 206 may be implemented with a circuit that is capable of generating a clock signal. For example, clock generation circuit 206 may be implemented using common clock recovery and/or generation circuits including PLLs, oscillators, voltage controlled oscillators, delay locked loops, frequency detectors, frequency multipliers/dividers, phase detectors, combinations of these circuits, or any other suitable circuit. Clock generation circuit 206 may also rely on other components, such as resistors, capacitors, inductors, crystals, or MEMS devices. Clock generation circuit 206 may also be programmable so that it may provide a clocking signal output that varies according to the inputs that it receives. For example, clock generation circuit 206 may be configured to produce a clocking signal of a very high quality (e.g., low jitter) when a reference clock signal is present on reference clock line 218b. Clock generation circuit 206 may also be configured to produce a clocking signal of a lower quality when a reference clock signal is absent. As other examples, the frequency, duty cycle, jitter, output skew, or propagation delay of the outputted clocking signal may be set according to inputs (e.g., control bits) that are provided to clock generation circuit 206 through bus 205. In alternative architectures, clock generation circuit 206 have directly access registers 212 without going through control circuit 204; in still other embodiments clock generation circuit 206 may have a register internal to itself for storing clock configuration information. While clock generation circuit 206 is shown to be part of storage controller 200, clock generation circuit 206 may also be implemented external to storage controller 200 without departing from the present disclosure.

Receiver circuit 208 and transmitter circuit 210 receive the internal clock signal on internal clock line 207 so that storage module 120 may transfer data to host 100 at higher rates than without a clock signal. In another embodiment, internal clock line 207 provides the internal clock signal to the receiver circuit 208, but not to the transmitter circuit 210. In yet another embodiment, internal clock line 207 provides the internal clock signal to the transmitter circuit 210, but not to the receiver circuit 208.

Registers 212 store one or more bits of information regarding the operation of storage module 120, including information regarding the operation of clock generation circuit 206 or other features of storage module 120. Registers 212 may be implemented as part of storage controller 200, as part of mass storage 202, as part of RAM 214, or as part of some other memory circuit in storage module 120. The memory used for registers 212 may be any type. For example, registers 212 may be implemented in volatile memory (e.g., SRAM, DRAM, or other volatile memory), non-volatile memory (e.g., flash memory, magnetic memory, resistive memory, or other), Read-Only Memory (ROM), one time programmable, or any combination of these or other types of memory.

Registers 212 may include several individual registers, e.g., registers 212a-212h of similar or different sizes. For example, register 212a may be a 1-byte register while registers 212b-212e are 1-bit registers and register 212f is a 4-byte register. Registers 212 may be used to store several specific types of information. In one case, some of registers 212 store read-only information that describes how storage module 120 operates (e.g., supported features) or configurations for storage module 120 to properly operate or operate at different levels of performance (e.g., configurations for different transfer rates). In another case, some of registers 212 store writeable information that configures how storage module 120 operates or what specifications storage module 120 uses to operate. In yet another case, some of registers 212 store information about how storage module 120 is currently operating or the current state of storage module 120. Together, registers 212 may also store all of the different types of information described above along with other types of data. Registers 212 may also be used to implement descriptors, flags, and attributes as described in JEDEC Standard No. 220A for Universal Flash Storage (UFS 1.1), published June 2012, which is incorporated by reference herein in its entirety.

In one case, registers 212 store information that describes a region of mass storage 202 that is write protected (either permanently or temporarily). For example, register 212f may define an address range, a block range, a partition, or the like that defines the region. Another register, e.g. register 212g, may define whether the region is permanently, temporarily, or authenticated write protected. In the case of permanent or temporary, the region is protected as described in U.S. Pat. No. 7,827,370, filed Jul. 8, 2005, which is hereby incorporated by reference in its entirety. However, in the case of the region being authenticated write protected, the region may be written/programmed to if authentication of the data to be written is successful.

Control circuit 204 may include a state machine or several state machines. In some embodiments, control circuit 204 may include a general purpose processor or microcontroller that is programmed to control storage module 120. For example, a processor programmed with firmware may implement one or more state machines that govern the operation of storage module 120. Firmware or other software for programming control circuit 204 may be stored in dedicated storage or in a reserved storage area on mass storage 202. As another alternative, control circuit 204 may be implemented as a combination of a general purpose processor programmed with firmware or the like and special purpose circuitry that performs specific functions.

Among the aspects of storage module 120 that control circuit 204 controls is the operation of clock generation circuit 206. In particular, using information stored in registers 212 and state information, which, in some examples, may also be stored in registers 212 or alternatively in RAM 214, control circuit 204 supplies control information (e.g., control bits) to clock generation circuit that controls the operation of the internal clock signal.

Other functions of control circuit 204 include receiving command signals from host 100 to perform certain functions. For example, control circuit 204 may receive command signals from host 100 to read information from or write information to registers 212. For instance, control circuit 204 may receive a command to read registers 212 in a location that stores a state of storage module 120 (e.g., a power state, a programming state, etc.).

It should be understood that the architecture of FIG. 2 is an example for ease of discussion only and should not be considered limiting on the disclosure. Circuits, buses, lines, modules and the like may have been simplified, left out, or otherwise combined with other components in FIG. 2. For example, storage module 120 is shown to have buses, such as internal clock line 207, bus 205, bus 213, bus 211, and bus 222; these buses may be removed, combined, rerouted, and/or added to without departing from the embodiments described herein. As another example, the functionality of control circuit 204 may be greatly expanded over what is described above and/or the functions described above by control circuit 204 may be spread across different circuits. Unless otherwise indicated herein, reference to a memory “block” also refers to a memory “bank.”

In a first embodiment, the firmware associated with the storage controller 200 has operating instructions that are associated with a specific file system in that the instructions are tuned to operate with the specific file system (i.e., the instructions are not generic to all file systems). Some other instructions in the firmware may be generic to work with all file systems. Other instructions are tuned to one or more specific file systems. For example, a firmware tuned for a journaling file system may have instructions that recognize read and write operations related to the journal and prioritize these operations or keep journal data in specific portions of memory. In another example, a firmware may be tuned to recognize read and write commands associated with the file allocation table (FAT) of the file systems. By recognizing how different file systems treat and store the FAT, storage module 120, through intelligence encoded in the firmware, may be able to optimize how operations involving the FAT are handled or store data in portions of storage module 120 in a way that improves or optimizes the performance or reliability of mass storage 202.

The firmware of the first embodiment may also have other operating instructions associated with other file systems. In this regard, the firmware may be optimized or otherwise improved for use with different file systems. Thus, in these embodiments, if a first file system of a first type is replaced with a second file system of a second type, then the firmware may not need to be updated. In these embodiments, the firmware is configured to detect that the file system has changed and to use the instructions associated with the file system on the second type instead of the instructions associated with the file system of the first type. In some embodiments, if the storage module has two or more partitions, each using a different file system with associated operating instructions in the firmware, then the firmware may be tuned to manage both partitions simultaneously with the instructions associated with each type of file system. The firmware may detect the type of file system through analysis of the data stored, by reading a register of storage module 120 that has previously been written with an indication of the file system type, or other similar methods.

The firmware operation may rely on parameters that are in the registers, thereby allowing the firmware to be tuned without updating the whole firmware. For example, one or more registers may be associated with a particular partition of the storage module. The parameter(s) in these registers may configure the firmware to operate in an improved or optimized manner with the particular partition without the firmware having to be aware of the exact file system being stored in the partition.

The storage module may request updated parameters or an updated firmware depending on what file system is detected. For example, if a firmware is configured for only one type of file system, but storage module 120 detects that a different file system is being used, then storage module 120 may inform host 100 that there is a file system mismatch. Storage module 120 may also request that host 100 download and install a new firmware that is configured for the file system currently being used.

Embodiments include a storage device, comprising means for storing data, such as e.g., the mass storage 202. The storage device comprises means for managing the means for storing data (such as e.g., the storage controller 200 and the control circuit 204), including managing at least a first portion of the means for storing data based at least in part upon first operating instructions in a firmware, the first operating instructions being associated with a first type of file system. The storage device further comprises means for providing an indication related to a mismatch between the first type of file system and a second type of file system detected to be used by a host device, such as e.g., data out line 215b, and data terminal 215a.

Although a feature may appear to be described in connection with a particular embodiment, one skilled in the art would recognize that various features of the described embodiments may be combined. Moreover, aspects described in connection with an embodiment may stand alone.

What is claimed is:

1. A storage device comprising:
a plurality of memory blocks each having a plurality of memory cells for storing data, the plurality of memory cells collectively forming a mass storage;
firmware that includes first operating instructions to manage a first portion of the mass storage, the first operating instructions being associated with a first type of file system; and
a controller configured to manage at least the first portion based at least in part upon the first operating instructions in the firmware, the controller operable to provide an indication related to a mismatch between the first type of file system and a second type of file system detected to be used by a host device.

2. The storage device of claim 1, wherein the indication relates to a request for the host device to cause installation of second operating instructions to manage a second portion of the mass storage based at least in part upon the second operating instructions, the second operating instructions being associated with the second type of file system.

3. The storage device of claim 1, wherein the controller is further configured to detect the second type of file system by analyzing at least a portion of the data stored in the mass storage.

4. The storage device of claim 1, wherein the controller is further configured to detect the second type of file system by reading a register of the storage device that has previously been written with another indication of the second type of file system.

5. The storage device of claim 1, wherein the controller is further configured to detect the first type of file system.

6. The storage device of claim 5, wherein the controller is further configured to store another indication of the first type of file system and transmit the other indication to the host device.

7. The storage device of claim 6, wherein the controller is further configured to read the other indication of the first type of file system.

8. The storage device of claim 1, further comprising:
a register for storing a parameter related to operation of the first type of file system, wherein the firmware includes instructions to read the parameter and configure the first operating instructions to manage the mass storage based on the parameter.

9. A storage device comprising:
a mass storage; and
a controller configured to manage at least a first portion of the mass storage based at least in part upon first operating instructions in a firmware of the storage device, the controller operable to provide an indication related to a mismatch between the first type of file system and a second type of file system detected to be used by a host device.

10. The storage device of claim 9, wherein the indication relates to a request for the host device to cause installation of second operating instructions to manage a second portion of the mass storage based at least in part upon the second operating instructions, the second operating instructions being associated with the second type of file system.

11. The storage device of claim 9, wherein the controller is further configured to detect the second type of file system by analyzing at least a portion of data stored in the mass storage.

12. The storage device of claim 9, wherein the controller is further configured to detect the second type of file system by reading a register of the storage device that has previously been written with another indication of the second type of file system.

13. The storage device of claim 9, wherein the controller is further configured to detect the first type of file system.

14. The storage device of claim 13, wherein the controller is further configured to store another indication of the first type of file system and transmit the other indication to the host device.

15. The storage device of claim 14, wherein the controller is further configured to read the other indication of the first type of file system.

16. The storage device of claim 9, further comprising:
a register for storing a parameter related to operation of the first type of file system, wherein the firmware includes instructions to read the parameter and configure the first operating instructions to manage the mass storage based on the parameter.

17. A method, comprising:
storing, by a controller of a storage device, data in a mass storage of the storage device;
managing, by the controller of the storage device, at least a first portion of the mass storage based at least in part upon first operating instructions in a firmware of the storage device; and
providing an indication related to a mismatch between the first type of file system and a second type of file system detected to be used by a host device.

18. The method of claim 17, wherein the indication relates to a request for the host device to cause installation of second operating instructions to manage a second portion of the mass storage based at least in part upon the second operating instructions, the second operating instructions being associated with the second type of file system.

19. The method of claim 17, further comprising detecting the second type of file system by one or more of analyzing at least a portion of the data stored in the mass storage or reading a register of the storage device that has previously been written with another indication of the second type of file system.

20. The method of claim 17, further comprising:
detecting the first type of file system;
storing another indication of the first type of file system; and
transmitting the other indication to the host device.

21. A host device, comprising:
an interface for interfacing the host device with a storage device that comprises a plurality of memory circuits for storing data, the storage device including a firmware having first operating instructions to manage a first portion of the mass storage, the first operating instructions being associated with a first type of file system; and
a host controller configured to:
receive, from the storage device, an indication related to a mismatch between the first type of file system and a second type of file system being used by the host device; and
provide to the storage device second operating instructions, the second operating instructions being associated with the second type of file system.

22. The host device of claim 21, wherein the indication relates to a request for the host device to cause installation of the second operating instructions.

23. A host device of claim 21, wherein the second operating instructions are for managing a second portion of the mass storage based at least in part upon the second operating instructions.

24. A storage device, comprising:
means for storing data;
means for managing the means for storing data, including managing at least a first portion of the means for storing data based at least in part upon first operating instructions in a firmware, the first operating instructions being associated with a first type of file system; and
means for providing an indication related to a mismatch between the first type of file system and a second type of file system detected to be used by a host device.

25. The storage device of claim 24, wherein the indication relates to a request for the host device to cause installation of second operating instructions to manage a second portion of the mass storage based at least in part upon the second operating instructions, the second operating instructions being associated with the second type of file system.
